(19) United States
(12) Patent Application Publication
(10) Pub. No.: US 2003/0095154 A1
(43) Pub. Date: May 22, 2003

(54) Method and apparatus for a gesture-based user interface

(75) Inventor: Antonio J. Colmenarez, Maracaibo (VE)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/988,944

(22) Filed: Nov. 19, 2001

(51) Int. Cl. G09G 5/00

(52) U.S. Cl. 345/863; 345/821; 345/860

(57) ABSTRACT

A visual user interface provided on a display. The display provides a plurality of selection options to a user. A processor is operatively coupled to the display for sequentially highlighting each of the plurality of selection options for a period of time. The processor, during the highlighting, receives one or more images of the user from an image input device and determines whether a selection gesture from the user is contained in the one or more images. When a selection gesture is contained in the one or more images, the processor performs an action determined by the highlighted selection option.

### FIELD OF THE INVENTION

This invention generally relates to a method and device for assisting user interaction with the device or another operatively coupled device. Specifically, the present invention relates to a user interface that utilizes gestures as a mode of user input for a device.

### BACKGROUND OF THE INVENTION

There are numerous systems that exist which use a computer vision system to acquire an image of a user for the purposes of enacting a user input function. In a known system, a user may point at one of a plurality of selection options on a display. The system, using one or more image acquisition devices, such as a single image camera or a motion image camera, acquires one or more images of the user pointing at the one of the plurality of selection options. Utilizing these one or more images, the system determines an angle of the pointing. The system then utilizes the angle of pointing, together with determined distance and height data, to determine which of the plurality of selection options the user is pointing to.

These systems all have a problem in accurately determining the intended selection option in that the location of the selection options on a given display must be precisely known for the system to determine the intended selection option. However, the location of these selection options varies for each differently sized display device. Accordingly, the systems must be specially programmed for each display size or a size selection must be made a part of a setup procedure.

Further, these known systems have problems in accurately determining the precise angle of pointing, height, etc. that is required for making a reliable determination. To solve these known deficiencies in the prior art, it is known to widely disperse the plurality of selection options on the display so that a given selection can be more readily identified from the unreliable determined data. However, on smaller displays there may not be sufficient display area to sufficiently disperse the selection options. Other known systems have utilized a confirmation gesture, after an initial pointing for item selection. For example, after a user has made a pointing item selection, a gesture, such as a thumbs-up gesture, may be utilized to confirm a given selection. Yet, the problems with identifying the selected option still exist.

Accordingly, it is an object of the present invention to overcome the disadvantages of the prior art.

### SUMMARY OF THE INVENTION

The present invention is a system having a video display device, such as a television, a processor, and an image acquisition device, such as a single image or motion image camera. The system provides a visual user interface on the display. In operation, the display provides a plurality of selection options to a user. The processor is operatively coupled to the display for sequentially highlighting each of the plurality of selection options for a period of time. The processor, during the highlighting, receives one or more images of the user from camera and determines whether a selection gesture from the user is contained in the one or more images.

When a selection gesture is contained in the one or more images, the processor performs an action determined by the highlighted selection option. When a selection option is not contained in the one or more images, the processor highlights a subsequent selection option. In this way, a robust system for soliciting user input is provided that overcomes the disadvantages found in prior art systems.

### BRIEF DESCRIPTION OF THE DRAWINGS

The following are descriptions of embodiments of the present invention that when taken in conjunction with the following drawings will demonstrate the above noted features and advantages, as well as further ones. It should be expressly understood that the drawings and following embodiments are included for illustrative purposes and do not represent the scope of the present invention that is defined by the appended claims. The invention is best understood in conjunction with the accompanying drawings in which:

FIG. 1 shows an illustrative system in accordance with an embodiment of the present invention; and

FIG. 2 shows a flow diagram illustrating an operation in accordance with an embodiment of the present invention.

### DETAILED DESCRIPTION OF THE INVENTION

In the discussion to follow, certain terms will be illustratively utilized in regard to specific embodiments or systems to facilitate the discussion. As would be readily apparent to a person of ordinary skill in the art, these terms should be understood to encompass other similar known terms and embodiments wherein the present invention may be readily applied.

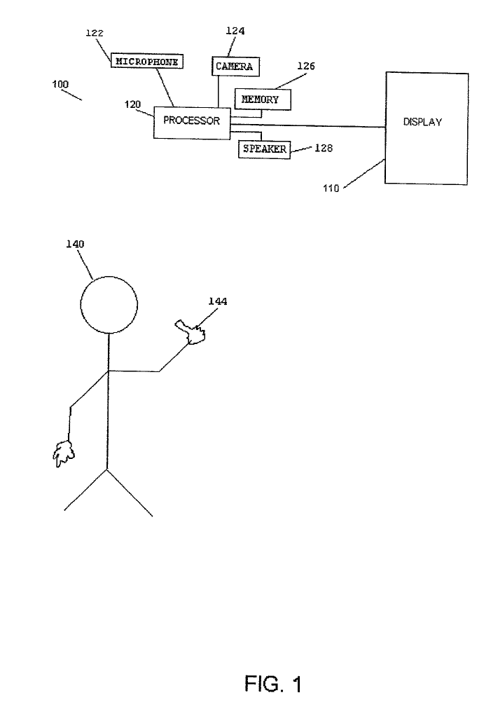

FIG. 1 shows an illustrative system 100 in accordance with an embodiment of the present invention including a display 110, operatively coupled to a processor 120. To facilitate operation in accordance with the present invention, the processor 120 is operatively coupled to an image input device, such as a camera 124. The camera 124 is utilized to capture selection gestures from a user 140. Specifically, in accordance with the present invention, a selection gesture, illustratively shown as a selection gesture 144 is utilized by the system 100 to determine which of a plurality of selection options is desired by the user as will be further described herein below.

It should be understood that the terms selection option, selection feature, etc. are utilized herein for describing any type of user input operation regardless of the purpose for the user input. These selection options may be displayed for any purpose including command and control features, interaction features, preference determination, etc.

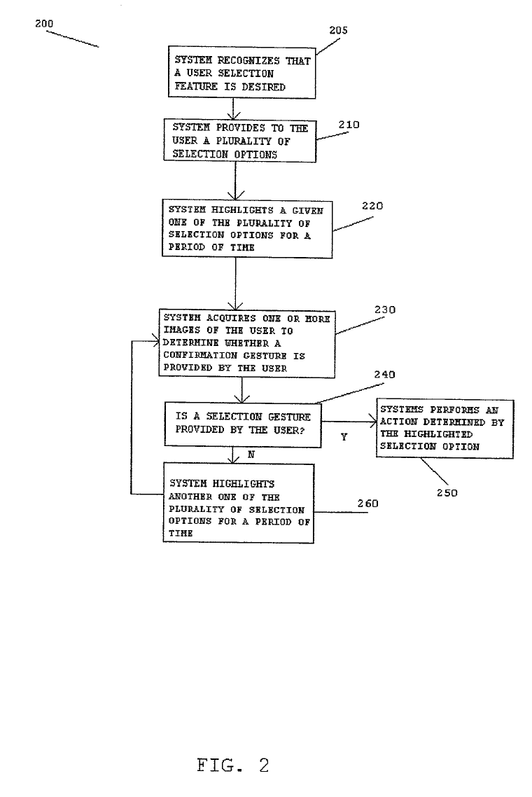

Further operation of the present invention will be described herein with regard to FIG. 2 that shows a flow diagram 200 in accordance with an embodiment of the present invention. As illustrated, during act 205 the system 100 recognizes that a user selection feature is desired by the user or required of the user.

There are many ways that are known in the art for activating a selection feature. For example, a user may depress a button located on a remote control (not shown). A user may depress a button located on the display 110 or on other operatively coupled devices. A user may utilize an audio indication or a particular gesture from the user to activate the selection feature. Operation of a gesture recognition system is provided further below. To facilitate use of an audio indication as a way of activating the selection feature, the processor may also be operatively coupled to an audio input device, such as a microphone 122. The microphone 122 may be utilized to capture audio indications from a user 140.

The system 100 may, as a result of a previous step or sequence of steps, provide the selection feature without further intervention by the user. For example, the system 100 may provide the selection feature when a device is first turned on or after some follow-up from a previous activity or selection (e.g., as a sub-menu). Further, the system 100 may detect the presence of a user in front of the system using the camera 124 and an acquired image or images of the area in front of the camera 124. In this embodiment, the presence of the user in front of the camera may act to initiate the selection feature. None of the above methods should be understood to be limitations on the present invention unless specifically required by the appended claims.

Whichever method is utilized for activating the selection feature, in act 210 the system provides to the user a plurality of selection options. These selection options may by provided on the display 110 all at once, or may be provided to the user in groups of one or more selection options.

A sliding or scrolling banner of selection options are examples of systems that may provide the selection options in groups of one or more selection options. Additionally, groups of one or more selection options may simply pop-up or appear on a portion of the display 110. In the display technology there are many other known effects for providing selection options on a display. Each of these should be understood to be considered as operating in accordance with the present invention.

Regardless of how the selection options are provided to the user, in act 220 the system 100 highlights a given one of the plurality of selection options for a period of time. The term highlight as used herein should be understood to encompass any way in which the system 100 indicates to the user 140 that a particular one of the plurality of selection options should be considered at a given time.

For a system wherein all of the plurality of selection options are provided to the user simultaneously, the system 100 may actually provide a highlighting effect. The highlighting effect, for example, may be a change in a color of a background of the given one or each other of the plurality of selection options. In one embodiment, the highlighting may be in the form of a change in a display characteristic of the selection option, such as a change in color, size, font, etc. of the given one or each other of the plurality of selection options.

In a system wherein the plurality of selection options are provided to the user sequentially, such as in the above noted scrolling banner presentation, then the highlighting may simply be provided by the order of presentation of selection options. For example, in one embodiment, one selection option may scroll onto the display as the previously displayed selection option disappears from the display. Thereafter, for some time, only one selection option is visible on the display. In this way, the highlighting is provided, in effect, by only having one selection option visible at that time. In another embodiment the highlighting may simply be intended to be for the last appearing selection option of a scrolling list wherein one or more of the previous selection options are still visible.

In yet another embodiment, the system 100 may be provided with a speaker 128 operatively coupled to the processor 120 for orally highlighting a given selection option. In this embodiment, the processor 120 may be operable to synthetically generate corresponding speech portions for each given one of the plurality of selection options. In this way, a speech portion may be presented to the user for highlighting a corresponding selection option in accordance with the present invention. The corresponding speech portion may simply be a text-to-speech conversion of the selection option or it may correspond to the selection option in other ways. For example, in an embodiment wherein the selection options are numbered, etc., the speech portion may simply be the number, etc. corresponding to the selection option. Other ways of corresponding a speech portion to a given selection option would occur to a person of ordinary skill in the art. Any of these other ways should be understood to be within the scope of the appended claims.

After the system highlights a given one of the plurality of selection options, then during act 230 the processor 120 may acquire one or more images of the user 140 through use of the camera 124. These one or more images are utilized by the system 100 for determining whether the user 140 is providing a selection gesture. There are many known systems for acquiring and recognizing a gesture of a user. For example, a publication entitled “Vision-Based Gesture Recognition: A Review” by Ying Wu and Thomas S. Huang, from Proceedings of International Gesture Workshop 1999 on Gesture-Based Communication in Human Computer Interaction, describes a use of gestures for control functions. This article is incorporated herein by reference as if set forth in its entirety herein.

In general, there are two types of systems for recognizing a gesture. In one system, referred to as hand posture recognition, the camera 124 may acquire one image or a sequence of a few images to determine an intended gesture by the user. This type of system generally makes a static assessment of a gesture by a user. In other known systems, the camera 124 may acquire a sequence of images to dynamically determine a gesture. This type of recognition system is generally referred to as dynamic/temporal gesture recognition. In some systems, analyzing the trajectory of the hand may be utilized for performing dynamic gesture recognition by comparing this trajectory to learned models of trajectories corresponding to specific gestures.

In any event, after the camera 124 acquires one or more images, during act 240, the processor 120 tries to determine whether a selection gesture is contained within the one or more images. Acceptable selection gestures may include hand gestures such as rising or waving of a hand, arm, fingers, etc. Other acceptable selection gestures may be head gestures such as the user 140 shaking or nodding their head. Further selection gestures may include facial gestures such as the user winking, rising their eyebrows, etc. Any one or more of these gestures may be recognizable as a selection gesture by the processor 120. Many other potential gestures would be apparent to a person of ordinary skill in the art. Any of these gestures should be understood to be encompassed by the appended claims.

When the processor 120 does not identify a selection gesture in the one or more images, the processor 120 returns to act 230 to acquire an additional one or more images of the user 140. After a predetermined number of attempts at determining a known gesture from one or more images without a known gesture being recognized or after a predetermined period of time, the processor 120 during act 260 highlights another one of the plurality of selection options. Thereafter, the system 100 returns to act 230 to await a selection gesture as described above.

When the processor 120 identifies a selection gesture during act 240, then during act 250 the processor 120 performs an action determined by the highlighted selection option. As discussed above, the action performed may be any action that is associated with the highlighted selection option. An associated action should be understood to include the action specifically called for by the selection option and may include any and/or all subsequent actions that may be associated therewith.

Finally, the above-discussion is intended to be merely illustrative of the present invention. Numerous alternative embodiments may be devised by those having ordinary skill in the art without departing from the spirit and scope of the following claims. For example, although the processor 120 is shown separate from the display 110, clearly both may be combined in a single display device such as a television, a set-top box, or in fact any other known device. In addition, the processor may be a dedicated processor for performing in accordance with the present invention or may be a general purpose processor wherein only one of many functions operate for performing in accordance with the present invention. The processor may operate utilizing a program portion, multiple program segments, or may be a hardware device utilizing a dedicated or multi-purpose integrated circuit.

The display 110 may be a television receiver or other device enabled to reproduce visual content to a user. The visual content may be a user interface in accordance with an embodiment of the present invention for enacting control or selection actions. In these embodiments, the display 110 may be an information screen such as a liquid crystal display (“LCD”), plasma display, or any other known means of providing visual content to a user. Accordingly, the term display should be understood to include any known means for providing visual content.

Numerous alternative embodiments may be devised by those having ordinary skill in the art without departing from the spirit and scope of the following claims. In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope; and

d) several “means” may be represented by the same item or hardware or software implemented structure or function.

The claimed invention is:

1. A video display device comprising:
a display configured to display a plurality of selection options;
a processor operatively coupled to the display and configured to sequentially highlight each of the plurality of selection options for a period of time and configured to receive a selection gesture from the user for selecting a highlighted selection option.

2. The video display device of claim 1, wherein the processor is configured to highlight each of the plurality of selection options by causing the display to display one of each of the plurality of selection options for the period of time.

3. The video display device of claim 1, wherein the processor is configured to highlight each of the plurality of selection options by causing the display to alter a display characteristic for one of each of the plurality of selection options for the period of time.

4. The video display device of claim 1, comprising an audio output device, wherein the processor is configured to highlight each of the plurality of selection options by causing the audio output device to sequentially output an audio indication associated with a corresponding one of each of the plurality of selection options.

5. The video display device of claim 1, comprising a camera operatively coupled to the processor for acquiring an image of the user containing the selection gesture.

6. The video display device of claim 5, wherein the image information is contained in a plurality of images and wherein the processor is configured to analyze the plurality of images to determine the selection gesture.

7. The video display device of claim 5, wherein the image information is contained in a plurality of images and wherein the processor is configured to determine the selection gesture by analyzing the plurality of images and determining a trajectory of a hand of the user.

8. The video display device of claim 1, wherein the processor is configured to determine the selection gesture by analyzing an image of the user and determining a posture of a hand of the user.

9. The video display device of claim 1, wherein the video display device is a television.

10. A method of providing a user interface containing a plurality of selection options, the method comprising the acts of:
displaying a plurality of selection options;
highlighting each one of the plurality of selection options sequentially;
analyzing an image of the user to determine whether the image contains a selection gesture for a highlighted selection option.

11. The method of claim 10, wherein analyzing the image comprises:
receiving a plurality of images; and
analyzing the plurality of images to determine whether the plurality of images contains a selection gesture.

12. The method of claim 10, wherein analyzing the image comprises:
receiving a plurality of images;
analyzing the plurality of images to determine a trajectory of a hand of the user; and
determining whether the plurality of images contains a selection gesture by the determined trajectory.

13. The method of claim 10, wherein analyzing the image comprises:
analyzing an image of the user to determine a posture of a hand of the user; and
determining whether the image contains a selection gesture by the determined posture.

14. A program portion stored on a processor readable medium for providing a user interface containing a plurality of selection options, the program segment comprising:
a program segment for controlling a display of the plurality of selection options;
a program segment for highlighting each one of the plurality of selection options for a period of time;
a program segment for analyzing an image of a user to determine whether the image contains a selection gesture; and
a program segment for performing a selection option if a selection gesture is received while the selection option is highlighted.

15. The program portion of claim 14, wherein the program segment for analyzing the image comprises:
a program segment for controlling receipt of a plurality of images; and
a program segment for analyzing the plurality of images to determine whether the selection gesture is received.

16. The program portion of claim 14, wherein the program segment for analyzing the image comprises:
a program segment for controlling receipt of a plurality of images;
a program segment for analyzing the plurality of images to determine a trajectory of a hand of the user; and
a program segment for determining whether the selection gesture is received by the determined trajectory.

17. The program portion of claim 14, wherein the program segment for analyzing the image comprises:
a program segment for analyzing an image of the user to determine a posture of a hand of the user; and
a program segment for determining whether the selection gesture is received by the determined posture.
